(19) United States
(12) Patent Application Publication
(10) Pub. No.: US 2025/0102477 A1
(43) Pub. Date: Mar. 27, 2025

(54) HIGH PRESSURE FLOW PROPORTIONING FOR STAGGERED CHROMATOGRAPHY USING A SINGLE PUMP

(71) Applicant: Waters Technologies Corporation, Milford, MA (US)

(72) Inventors: Andrew Keaveney, Manchester (GB); Sean Reilly, North Smithfield, RI (US); Michael R. Jackson, Woonsocket, RI (US); Matthew Clive Gill, Derbyshire (GB)

(21) Appl. No.: 18/889,823

(22) Filed: Sep. 19, 2024

Related U.S. Application Data
(60) Provisional application No. 63/539,945, filed on Sep. 22, 2023.

(51) Int. Cl. G01N 30/32; B01D 15/16; G01N 30/02; G01N 30/34

(52) U.S. Cl. CPC G01N 30/32; B01D 15/163; B01D 15/166; G01N 30/34; G01N 2030/027; G01N 2030/326; G01N 2030/328; G01N 2030/347

(57) ABSTRACT

A system and method for performing staggered separations are described. The system includes a plurality of solvent pumps; a plurality of proportioning valves each being in fluid communication with one of the solvent pumps, each proportioning valve having an inlet to receive a solvent from the respective one of the solvent pumps and having a plurality of outlets, wherein the proportioning valves are configured to control a flow of the solvent from each of the outlets; and a plurality of separation devices each in fluid communication with one of the outlets. Each of the separation devices receives a solvent mixture having a composition defined by the flows of the solvents from each of the respective outlets.

### RELATED APPLICATION

This application is a non-provisional patent application claiming priority to U.S. Provisional Patent Application No. 63/539,945, filed Sep. 22, 2023 and titled “High Pressure Flow Proportioning for Staggered Chromatography Using a Single Pump,” which is incorporated herein by reference.

### FIELD OF THE INVENTION

The disclosed technology generally relates to a high-throughput liquid chromatography-mass spectrometry (LC-MS) system. More particularly, the technology relates to an LC-MS system having a single pump system shared by multiple chromatography columns.

### BACKGROUND

Staggered chromatography techniques allow for higher utilization of mass spectrometer systems. Commercially available staggered LC-MS systems use a high-performance pump for each chromatographic channel. For example, for a system having a plurality of chromatography columns, each column is supplied with a gradient mobile phase provided by a pump dedicated to each column.

A staggered chromatography system typically requires a large hardware footprint, complex software orchestration, complex fluidics layout, and high hardware costs and maintenance costs.

### SUMMARY

In one aspect, a liquid chromatography system comprises a plurality of solvent pumps; a plurality of proportioning valves each being in fluid communication with one of the solvent pumps, each proportioning valve having an inlet to receive a solvent from the respective one of the solvent pumps and having a plurality of outlets, wherein the proportioning valves are configured to control a flow of the solvent from each of the outlets; and a plurality of separation devices each in fluid communication with one of the outlets. Each of the separation devices receives a solvent mixture having a composition defined by the flows of the solvents from each of the respective outlets.

The liquid chromatography system may further comprise a controller in communication with the proportioning valves. The controller may send a control signal to each of the proportioning valves to thereby control a composition of each solvent mixture.

The compositions may be gradient compositions. The gradient of each solvent mixture may be offset in time from the gradient composition of each of the other solvent mixtures.

Each proportioning valve may output a controlled output that varies over time such that a gradient composition is created at each channel.

The proportioning valves may comprise a first proportioning valve and a plurality of second proportioning valves. Each first proportioning valve may have a first valve inlet and a plurality of first valve outlets and each second proportioning valve having a second valve inlet in fluid communication with one of the first valve outlets and having a plurality of second valve outlets each in fluid communication with one of the separation devices.

The separation device may be a solid phase extraction device.

The separation device may be a chromatographic column.

The liquid chromatography system may further comprise a plurality of mixers, each mixer having a plurality of mixer inlets and a mixer outlet. Each mixer inlet may be in fluid communication with a respective one of the outlets of each of the proportioning valves and each mixer outlet is in fluid communication with one of the separation devices.

The liquid chromatography system may further comprise a plurality of injection valves. Each injection valve may be upstream from and in fluid communication with one of the separation devices.

The liquid chromatography system may further comprise a plurality of injection valves. Each injection valve may be disposed between and in fluid communication with one of the mixers and a respective one of the separation devices.

The composition may be an isocratic composition.

The liquid chromatography system may further comprise at least one solvent selection valve in fluid communication with one of the solvent pumps and configured for coupling to a plurality of solvent reservoirs.

The liquid chromatography system may further comprise at least one waste diverter valve.

At least one of the proportioning valves may comprise a rotary shear seal valve.

At least one of the proportioning valves may comprise a solenoid proportioning valve.

Each proportioning valve may be configurable so that a flow of solvent does not flow to at least one of the mixers.

In another aspect, a method for performing staggered separations comprises providing a plurality of proportioning valve modules having an inlet and a plurality of outlets; providing a plurality of solvent flows comprising a solvent that is different from the solvent of the other solvent flows, wherein each of the solvent flows is provided to the inlet of a respective one of the proportioning valve modules; controlling each of the proportioning valve modules to modulate the flow from the inlet to one or more of the outlets; and mixing the flow from each outlet of each proportioning valve module with a flow from a corresponding outlet of each of the other proportioning valve modules to generate a plurality of solvent mixture flows.

The method may further comprise providing each of the solvent mixture flows to a separation device.

The solvent mixture flows may have a gradient composition.

The gradient compositions may be offset in time from each other.

### BRIEF DESCRIPTION OF THE DRAWINGS

The above and further advantages of this invention may be better understood by referring to the following description in conjunction with the accompanying drawings, in which like numerals indicate like structural elements and features in the various figures. For clarity, not every element may be labeled in every figure. The drawings are not necessarily to scale, emphasis instead being placed upon illustrating the principles of the invention.

FIG. 1 is a schematic illustration of a staggered liquid chromatography system, in accordance with some embodiments of the present inventive concept.

FIGS. 2-4 depict graphs in accordance with some embodiments.

FIG. 5 is a schematic illustration of a staggered liquid chromatography system, in accordance with other embodiments of the present inventive concept.

FIG. 6 is a flow diagram of a method for solvent flow control of a liquid chromatography system, in accordance with some embodiments of the present inventive concept.

### DETAILED DESCRIPTION

Reference in the specification to an embodiment or example means that a particular feature, structure, or characteristic described in connection with the embodiment or example is included in at least one embodiment or example of the teaching. References to a particular embodiment or example within the specification do not necessarily all refer to the same embodiment or example.

The present teaching will now be described in detail with reference to exemplary embodiments or examples thereof as shown in the accompanying drawings. While the present teaching is described in conjunction with various embodiments and examples, it is not intended that the present teaching be limited to such embodiments and examples. On the contrary, the present teaching encompasses various alternatives, modifications, and equivalents, as will be appreciated by those of skill in the art. Moreover, features illustrated or described for one embodiment or example may be combined with features for one or more other embodiments or examples. Those of ordinary skill having access to the teaching herein will recognize additional implementations, modifications, and embodiments, as well as other fields of use, which are within the scope of the present disclosure as described herein.

As used herein, a “proportioning valve” means a valve that can modulate a flow received at a valve inlet into flows dispensed from two or more valve outlets. Non-limiting examples of proportioning valves include a rotary shear seal valve, a solenoid proportioning valve, or any other valve that can mix one or more kinds of mobile phases according to a predetermined setting for mixing proportions from a mobile phase flow and can control an amount of flow presented across its outlets. A “high pressure proportioning valve” means a proportioning valve that is configured to operate at a pressure ranging from 100-30,000 psi, but not limited thereto. A “proportioning valve module” means one or more proportioning valves that collectively operate so that a flow received at an inlet of the module is dispensed from two or more outlets of the module. For example, a single proportioning valve having one inlet and four outlets may be functionally replaced by three proportioning valves each having one inlet and two outlets.

Staggered LC-MS systems may be subject to high utilization and reliability is of significant importance. Although staggered LC-MS systems achieve high throughput, such systems have their disadvantages. Each chromatographic channel has a dedicated pump system to provide the mobile phase. Thus, the total system has a large hardware footprint, which can be problematic in laboratories where space to accommodate the system is often limited. Moreover, such systems typically come with high acquisition and maintenance costs and the software used to operate and control the system can be complex.

Another disadvantage is the complexity of configuring and plumbing the multiple pumps in an LC-MS system, often resulting in complex and confusing routing of fluidic lines (tubing). Additionally, the acoustic noise generated by the pumps can be significant.

In one example, to achieve throughputs that are similar to immunoassay systems that operate in hospital core laboratories, it is desirable to process 100 samples per hour. Thus, a sample would be processed in 37 seconds or less. Typical LC-MS system run times are currently significantly longer than this rate.

In order to achieve the equivalent throughput of an immunoassay, it is desirable to run many channels of chromatography. The number of channels required to achieve 100% MS utilization is related to the ratio between ratio of the useful analysis time and the inject-to-inject time. For example, to reach 100% MS utilization, an application including Vitamin D requires 7 channels. An application including immunosuppressants requires 5 channels. An application including steroids (steroid panel and thyroid) requires 3 channels. An application including Drugs of Abuse (DOA) confirmatory requires 3 channels.

Most LC-MS applications require a mobile phase to be delivered to a column at a composition and a flow rate that vary with time. In staggered chromatography, the gradient provided to each column is offset in time from the gradients provided to each of the other columns to allow the mass spectrometer to detect the samples of interest individually. For example, for a system having four chromatographic channels, the offset interval is the total chromatographic run time for a single channel divided by four. Analytes of interest will elute off the columns sequentially spaced apart in time by the offset interval.

In brief overview, disclosed is a liquid chromatography system that permits an increased number of samples (as compared to conventional systems) to be provided through the system at higher throughputs using less hardware, e.g., no requirement for a pump system for each channel. To achieve this, in the various embodiments described herein, a multi-channel staggered chromatography system includes a single pump system for multiple channels. A proportioning valve splits the flow of a mobile phase from a single pump into multiple streams wherein the split proportions in each stream vary over time. The number of solvents that are mixed to generate the gradient mobile phase determines, at least in part, the number of proportioning valves that are used. In some implementations, a binary gradient mobile phase is used with each chromatographic channel and a binary solvent manager (BSM) pump system is used, although, in other implementations, three or more solvents may be used to form the gradient mobile phase. For example, a quaternary solvent manager (QSM) may allow four distinct components, and the implementation of a solvent extension valve may be used to generate a mobile phase that further increases the number of distinct solvent components.

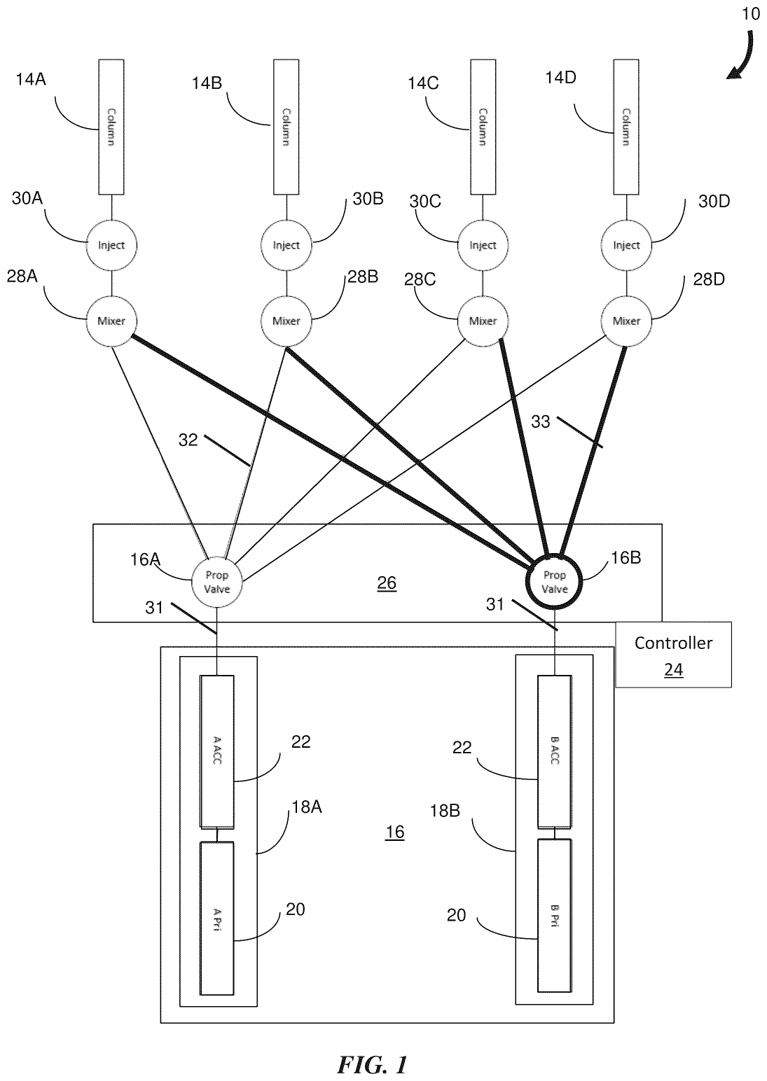

FIG. 1 is a schematic illustration of a staggered liquid chromatography system 10 having four chromatographic columns 14A to 14D (generally 14) and a BSM 16 having two solvent pumps 18A and 18B (generally 18). In some embodiments, other separation devices, i.e., other than a chromatographic column, may equally apply, such as a solid phase extraction device.

Each column 14 receives a source of the same solvent during operation. Additional components illustrated in the figure are identified by reference numbers appended with an “A,” “B,” “C,” or “D” used to indicate an associate with a corresponding one of the columns 14 or solvent pumps 18. Each solvent pump 18 includes a primary actuator 20 and an accumulator actuator 22. The primary actuator 20 draws solvent from a solvent reservoir (not shown) and delivers it to the accumulator actuator 22 which provides a high-pressure flow of the solvent to a corresponding port of the BSM 16. The flow rate from each solvent pump 18 may be independently controlled, i.e., having independent piston drives or the like for controlling the flow of solvent. A controller 24 may be in communication with the proportioning valve module 26, and operate to send a control signal to each of the proportioning valves 16 to thereby control a composition of each solvent mixture. In some embodiments, the controller 24 may be part of a printed circuit board (PCB) or related computer-based hardware processor. In some embodiments, the controller 24 is integrated with a pump. In other embodiments, the controller 24 is a standalone device. In some embodiments, the composition may be an isocratic composition but not limited thereto.

The liquid chromatography system 10 further includes a proportioning valve module 26, four mixers 28A-28D (generally 28) and four injector valves 30A-30D (generally 30). The proportioning valve module 26 has an inlet 31 for each solvent pump 18 and a plurality of outlets 32. Each inlet 31 is in fluid communication with a corresponding solvent pump 18 to receive the controlled high-pressure flow of solvent.

The proportioning valve module 26 is constructed and arranged for distributing the mobile phase received from the pumps to the different mixers 28. In the illustrated embodiment, the proportioning valve module 26 includes a first proportioning valve 16A and a second proportioning valve 16B. The proportioning valves 16A, 16B (generally 16) are constructed and arranged to vary the composition and flow rates of mobile phases delivered to the multiple chromatographic channels over time in a sweeping manner. In other words, the system sweeps between each channel by varying the flow rate at each output of the proportioning valve to adjust the gradient of each channel. For example, a first solvent can be delivered to the four mixers 28A-28D from the first proportioning valve 16A, and a second solvent can be delivered to the four mixers 28A-28D from the first proportioning valve 16B, where each mixer can perform a mixing operation on the first and second solvents.

Accordingly, the outlets of the BSM 16 are in fluid communication to an inlet 31 of a high-pressure proportioning valve 16 having four valve outlets 32. Each valve outlet for each of the two valves is coupled to one of four mixers 28. Each mixer 28 is fluidically coupled to an inlet of one of the chromatographic columns 14. Thus, each mixer 28 and injector valve 30 forms a fluid path with a column 14 and the programming valve module 26. For each column, an injection valve 30 is disposed in the fluid path between the respective mixer and the column to inject a sample into the flow to the inlet of the column so that the column can receive a composition gradient.

In brief overview, a system for performing separations such as a liquid chromatography system or a solid phase extraction (SPE) system using high pressure proportioning valves to vary the composition and/or flow rates of mobile phases delivered to multiple chromatographic channels over time. As described above, conventional LC-MS systems generally require multiple mobile phases to be delivered to a column at a composition and flow rate that varies with time. The system according to embodiments of the present inventive concept, on the other hand, include a proportioning valve that splits the flow of a mobile phase from a single pump into multiple streams, with the split proportions in each stream varying over time. The number of mobile phases that require mixing determines the number of proportioning valves to be used. For example, two mobile phases may require two proportioning valves, for example, shown in FIG. 1. Also shown in FIG. 1 is a 4-channel staggered LC-MS example, where a single BSM pump is required to provide 4 LC channels. In some embodiments, the BSM pump may have two proportioning valves, negating the need for 4 BSM pumps to generate a desired 4 chromatographic gradients over 4 columns.

In some embodiments, the liquid chromatography system 10 includes at least one solvent selection valve in fluid communication with one of the solvent pumps 18 and is configured for coupling to a plurality of solvent reservoirs. The solvent selection valve may be used to facilitate the simultaneous or near simultaneous flow of different solvents. In some embodiments, the liquid chromatography system 10 further comprises at least one waste diverter valve, which may allow a single proportioning valve to be employed with a pre-proportioning valve mixing operation.

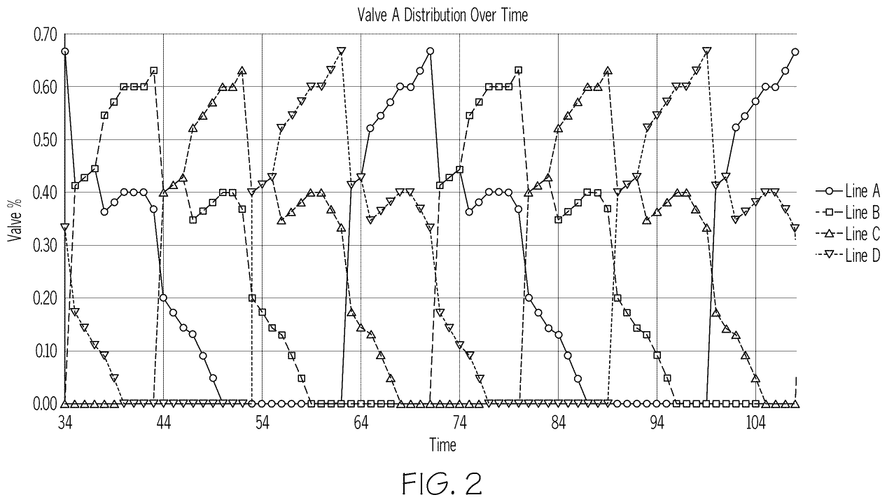

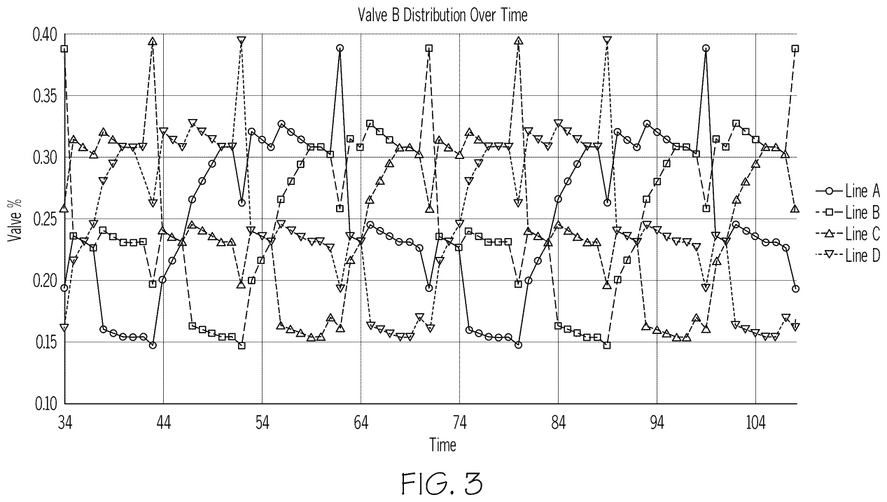

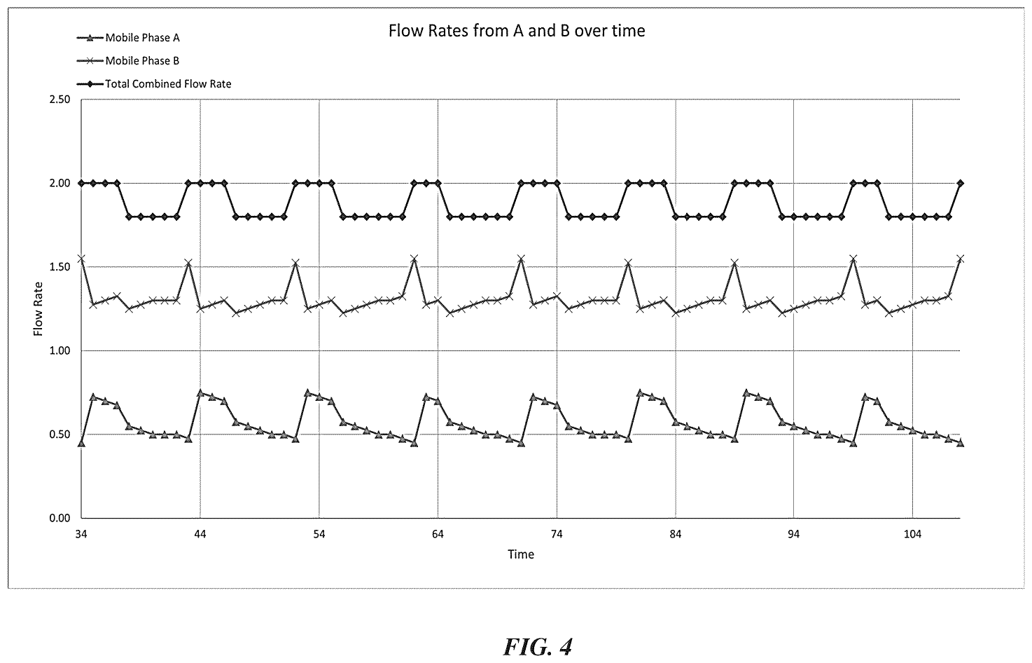

FIGS. 2 and 3 depict percentage splits over time delivered to the four columns 14 illustrated in FIG. 1 for an example LC application. FIG. 4 depicts the changes to the delivered flow rate from each actuator.

In particular, FIG. 2 illustrates split proportions, or percentages, of the four output lines 32 of the first proportioning valve 16A for delivery to the four columns 14A-14D over time. FIG. 2 also shows the percentage(s) of the received flow that would be given to each of the channels, and how this would vary over time to meet the gradient needs of each channel. FIG. 3 illustrates split proportions, or percentages, of the four output lines 33 of the second proportioning valve 16B for delivery to the four columns 14A-14D over time. These graphs simulate how the two four-outlet valves illustrated in FIG. 1 may be used for a particular experiment, namely, a Therapeutic Drug Monitoring experiment. As shown, the output of the valves varies over time in a ‘sweeping’ manner, as illustrated in the cyclic nature of the graphs.

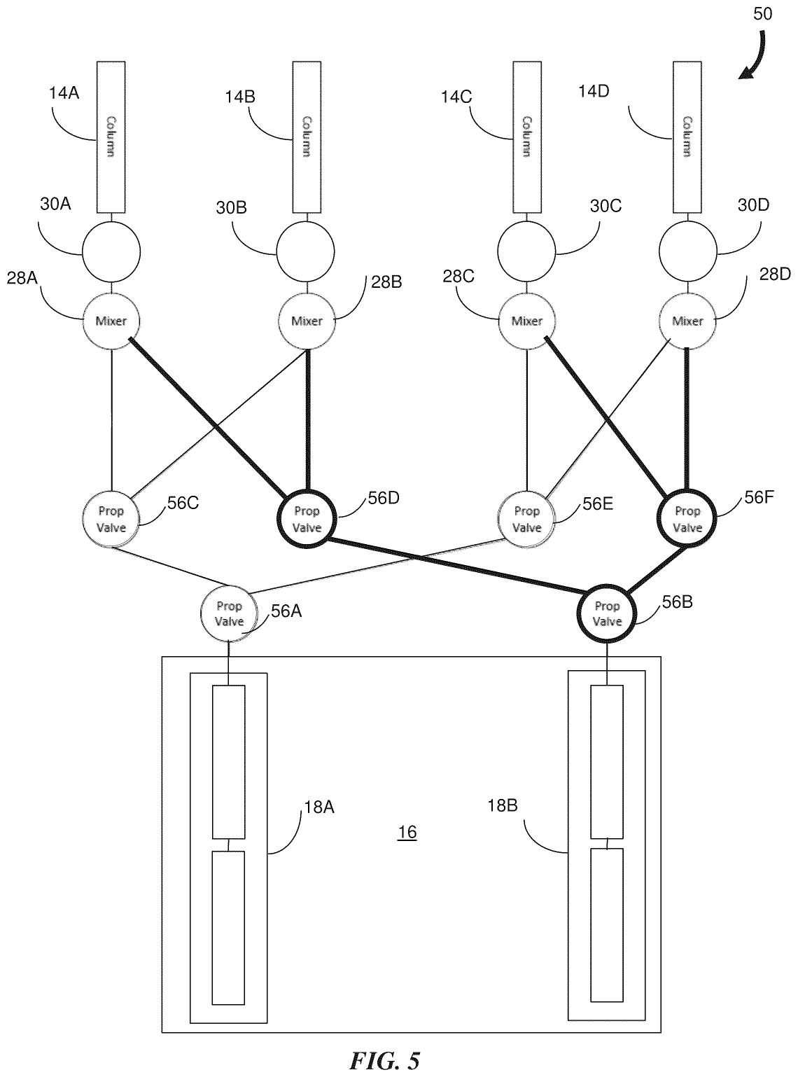

FIG. 5 is a schematic illustration of a staggered liquid chromatography system 50, in accordance with other embodiments of the present inventive concept. The system 50 includes a plurality of two-way proportioning valves 56A-56F rather than four-way proportioning valves. The two-way proportioning valves 56A-56F may be less expensive and easier to procure than four-way proportioning valves. Features, benefits, operations, and results of the system 50 may be similar to those of the system 10 of FIG. 1.

In some embodiments, a liquid chromatography system includes at least one waste diverter valve, which allows a single proportioning valve to be employed with a pre-proportioning valve mixing system.

In some embodiments, a liquid chromatography system can include a greater number of chromatography channels than those described herein, the number of channels subject to the capacity of the pumps and the application employed such as UPLC pumps or the like.

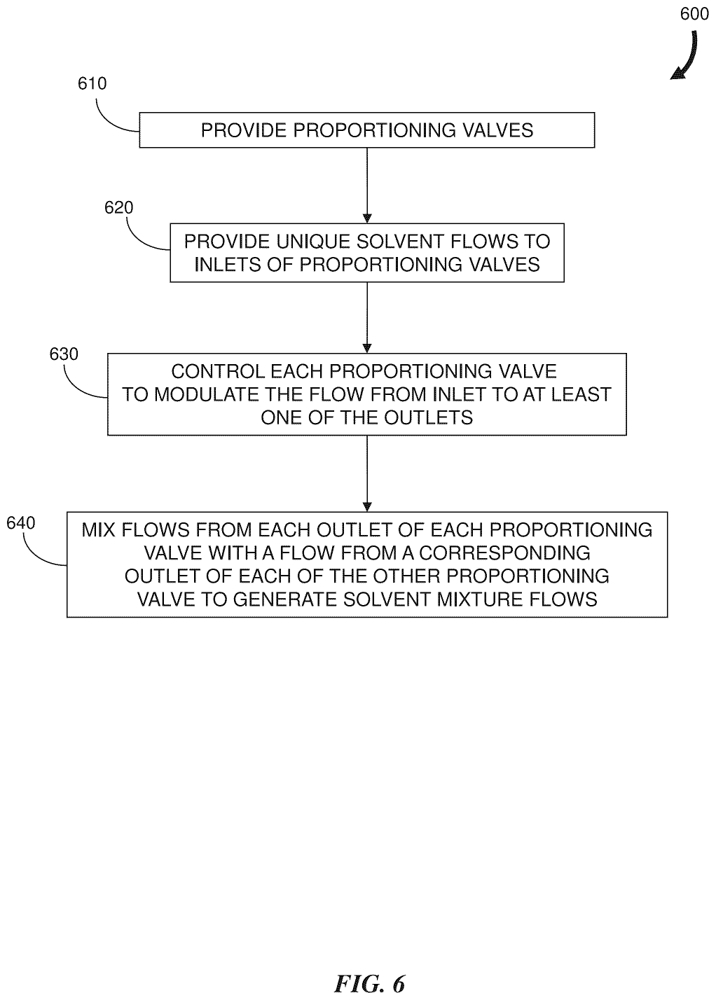

FIG. 6 is a flow diagram of a method 600 for solvent flow control of a liquid chromatography system, in accordance with some embodiments of the present inventive concept. In describing the method 600 references can be made of the liquid chromatography system 10 of FIG. 1 or the liquid chromatography system 50 of FIG. 5.

At block 610, a plurality of proportioning valves is provided. In some embodiments, two four-way proportioning valves are provided, for example, shown in FIG. 1. In other embodiments, an arrangement of six two-way proportioning valves is provided, for example, shown in FIG. 5. The number of proportioning valves may depend on the number of actuators and/or columns of the liquid chromatography system.

At block 620, at least one unique solvent flow is provided to the inlets of the proportioning valves.

At block 630, each proportioning valve is controlled to modulate the flow from the corresponding inlet to at least one of the outlets.

At block 640, the flows from each outlet of each proportioning valve are mixed with a flow from a corresponding outlet of each of the other proportioning valves to generate the desired solvent mixture flows.

While various examples have been shown and described, the description is intended to be exemplary, rather than limiting and it should be understood by those of ordinary skill in the art that various changes in form and detail may be made therein without departing from the scope of the invention as recited in the accompanying claims.

What is claimed is:

1. A liquid chromatography system, comprising:
a plurality of solvent pumps;
a plurality of proportioning valves each being in fluid communication with one of the solvent pumps, each proportioning valve having an inlet to receive a solvent from the respective one of the solvent pumps and having a plurality of outlets, and the proportioning valves are configured to control a flow of the solvent from each of the outlets; and
a plurality of separation devices each in fluid communication with one of the outlets, wherein each of the separation devices receives a solvent mixture having a composition defined by the flows of the solvents from each of the respective outlets.

2. The liquid chromatography system of claim 1, further comprising a controller in communication with the proportioning valves and wherein the controller operates to send a control signal to each of the proportioning valves to thereby control a composition of each solvent mixture.

3. The liquid chromatography system of claim 2, wherein the compositions are gradient compositions and wherein the gradient of each solvent mixture is offset in time from the gradient composition of each of the other solvent mixtures.

4. The liquid chromatography system of claim 1, wherein each proportioning valve outputs a controlled output that is varied over time such that a gradient composition is created at each channel.

5. The liquid chromatography system of claim 1, wherein the plurality of proportioning valves comprises a first proportioning valve and a plurality of second proportioning valves, each first proportioning valve having a first valve inlet and a plurality of first valve outlets and each second proportioning valve having a second valve inlet in fluid communication with one of the first valve outlets and having a plurality of second valve outlets each in fluid communication with one of the separation devices.

6. The liquid chromatography system of claim 1, wherein the separation device is a chromatographic column.

7. The liquid chromatography system of claim 1, wherein the separation device is a solid phase extraction device.

8. The liquid chromatography system of claim 1, further comprising a plurality of mixers, each mixer having a plurality of mixer inlets and a mixer outlet, wherein each mixer inlet is in fluid communication with a respective one of the outlets of each of the proportioning valves and each mixer outlet is in fluid communication with one of the separation devices.

9. The liquid chromatography system of claim 1, further comprising a plurality of injection valves, wherein each injection valve is upstream from and in fluid communication with one of the separation devices.

10. The liquid chromatography system of claim 1, further comprising a plurality of injection valves, wherein each injection valve is disposed between and in fluid communication with one of the mixers and a respective one of the separation devices.

11. The liquid chromatography system of claim 1, wherein the composition is an isocratic composition.

12. The liquid chromatography system of claim 1, further comprising at least one solvent selection valve in fluid communication with one of the solvent pumps and configured for coupling to a plurality of solvent reservoirs.

13. The liquid chromatography system of claim 1, further comprising at least one waste diverter valve.

14. The liquid chromatography system of claim 1, wherein at least one of the proportioning valves comprises a rotary shear seal valve.

15. The liquid chromatography system of claim 1, wherein at least one of the proportioning valves comprises a solenoid proportioning valve.

16. The liquid chromatography system of claim 1, wherein each proportioning valve is configurable so that a flow of solvent does not flow to at least one of the mixers.

17. A method for performing staggered separations, the method comprising:
providing a plurality of proportioning valve modules having an inlet and a plurality of outlets;
providing a plurality of solvent flows comprising a solvent that is different from the solvent of the other solvent flows, wherein each of the solvent flows is provided to the inlet of a respective one of the proportioning valve modules;
controlling each of the proportioning valve modules to modulate the flow from the inlet to one or more of the outlets; and
mixing the flow from each outlet of each proportioning valve module with a flow from a corresponding outlet of each of the other proportioning valve modules to generate a plurality of solvent mixture flows.

18. The method of claim 17, further comprising: providing each of the solvent mixture flows to a separation device.

19. The method of claim 17, wherein the solvent mixture flows have a gradient composition.

20. The method of claim 19, wherein the gradient compositions are offset in time from each other.
